(19) United States
(12) Patent Application Publication
(10) Pub. No.: US 2013/0332823 A1
(43) Pub. Date: Dec. 12, 2013

(54) DEVICES AND METHODS FOR SETTING TEXT-APPEARANCE FORMATION OF MOBILE TERMINALS AND MOBILE TERMINAL

(71) Applicant: MEDIATEK SINGAPORE PTE. LTD., Singapore (SG)

(72) Inventor: Xin-xin LIU, Beijing (CN)

(73) Assignee: MediaTek Singapore Pte. Ltd., Singapore (SG)

(21) Appl. No.: 13/799,809

(22) Filed: Mar. 13, 2013

(30) Foreign Application Priority Data
Jun. 6, 2012 (CN) 201210185834.5

(51) Int. Cl. G06F 17/21

(52) U.S. Cl. CPC G06F 17/214
USPC 715/269

(57) ABSTRACT

A device for setting text-appearance formation of a mobile terminal is provided. The device includes a command receiver, a text-appearance formation selector, and a text-appearance formation transformer. The command receiver is configured to receive a first operation command and a second operation command used for changing the text-appearance formation. The text-appearance formation selector is configured to provide a plurality of setting items of the text-appearance formation according to the first operation command and select at least one setting item of the text-appearance formation according to the second operation command. The text-appearance formation transformer is coupled to the text-appearance formation selector and configured to change the text-appearance formation according to the at least one selected setting item of the text-appearance formation.

### CROSS REFERENCE TO RELATED APPLICATIONS

This application claims priority of China Patent Application No. 201210185834.5, filed on Jun. 6, 2012, the entirety of which is incorporated by reference herein.

### BACKGROUND OF THE INVENTION

1. Field of the Invention

The invention relates to mobile communication technique, and more particularly to a device and method for setting the text-appearance formation on mobile terminals.

2. Description of the Related Art

In recent years, smartphones have developed to provide various applications and services to phone terminals, such that smartphones have become popular. Based on the platforms of smartphones, users can download various applications that they require according to their needs and desires, thus individualizing their smartphones.

However, the appearance style provided by current mobile-phone applications, or apps, such as text-appearance formations, usually use the standard appearance available on the mobile phones themselves. For example, for mobile phones of the same type, text-appearance style and the text-appearance formation provided by the message apps are the same. Only text-editing operations, such as cutting, copying, and pasting, are provided for the user. The apps do not allow users to choose or customize the appearance style of the text display on their mobile phones.

Many mobile phone users desire to set the appearance styles of their applications, especially the way text is displayed. They want their mobile phones to look more unique and individual by setting these “text-appearance formations,” such that the mobile phones look more tailored to their own needs and their own personalities.

### BRIEF SUMMARY OF THE INVENTION

Accordingly, it is desirable to provide a device and method for setting text-appearance formation of a mobile terminal for solving the above problems.

An exemplary embodiment of a device for setting text-appearance formation of a mobile terminal is provided. The device comprises a command receiver, a text-appearance formation selector, and a text-appearance formation transformer. The command receiver is configured to receive a first operation command and a second operation command used for changing the text-appearance formation. The text-appearance formation selector is configured to provide a plurality of setting items of the text-appearance formation according to the first operation command and select at least one setting item of the text-appearance formation according to the second operation command. The text-appearance formation transformer is coupled to the text-appearance formation selector and configured to change the text-appearance formation according to the at least one selected setting item of the text-appearance formation.

An exemplary embodiment of a method for setting text-appearance formation of a mobile terminal is provided. The method comprises the steps of: receiving a first operation command used for changing the text-appearance formation; providing a plurality of setting items of the text-appearance formation according to the first operation command; receiving a second operation command used for changing the text-appearance formation; selecting at least one setting item of the text-appearance formation according to the second operation command; and changing the text-appearance formation according to the at least one selected setting item of the text-appearance formation.

An exemplary embodiment of a mobile terminal is provided. The mobile terminal comprises a device for setting text-appearance formation of a mobile terminal. The device comprises a command receiver, a text-appearance formation selector, and a text-appearance formation transformer. The command receiver receives a first operation command and a second operation command used for changing the text-appearance formation. The text-appearance formation selector is configured to provide a plurality of setting items of the text-appearance formation according to the first operation command and select at least one setting item of the text-appearance formation according to the second operation command. The text-appearance formation transformer is coupled to the text-appearance formation selector and configured to change the text-appearance formation according to the at least one selected setting item of the text-appearance formation.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a device for setting the text-appearance formation of a mobile terminal;

FIG. 2A is a schematic view showing that an operation command is generated by touching a selected text in a text view displayed on a mobile terminal with one long touch;

FIG. 2B is a schematic view showing a text view and a selected text;

FIG. 3 is a schematic view showing an exemplary embodiment of setting items of the text-appearance formation;

FIG. 4 is a schematic view showing a plurality of predetermined setting references in a setting item of the text-appearance formation;

FIG. 5 shows another exemplary embodiment of a device for setting the text-appearance formation of a mobile terminal;

FIG. 6 is a schematic view showing a pop-up menu;

FIG. 7 is a flow chart of an exemplary embodiment of a method for setting the text-appearance formation of a mobile terminal;

FIG. 8 is a flow chart of another exemplary embodiment of a method for setting the text-appearance formation of a mobile terminal; and

FIG. 9 is a flow chart of further another exemplary embodiment of a method for setting the text-appearance formation of a mobile terminal.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

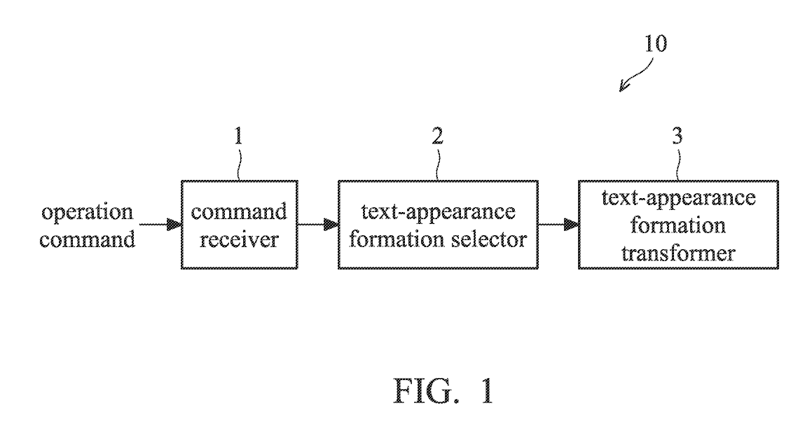

FIG. 1 shows an exemplary embodiment of a device 10 for setting a text-appearance formation of a mobile terminal. As shown in FIG. 1, the device 10 comprises a command receiver 1, a text-appearance formation selector 2, and a text-appearance formation transformer 3.

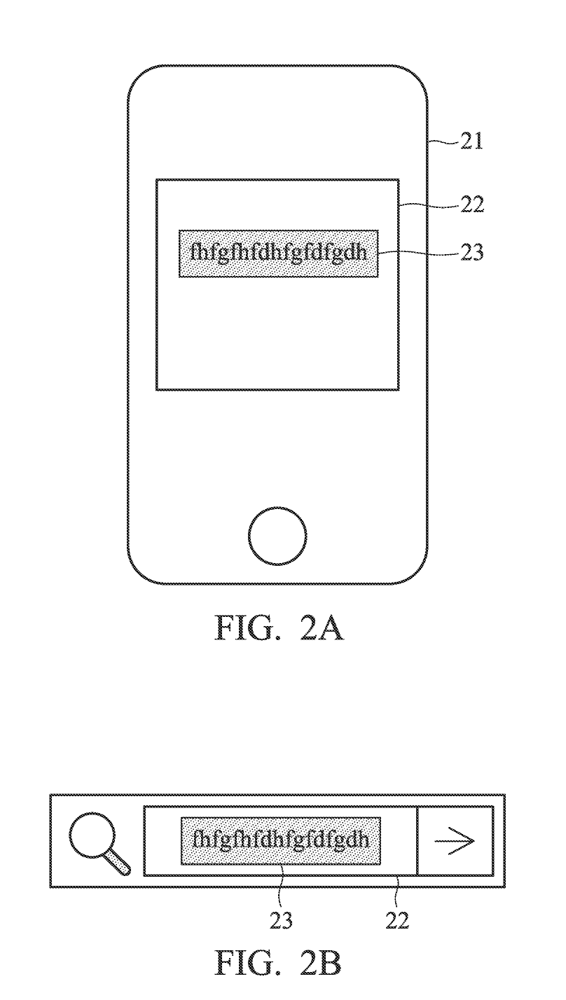

The command receiver 1 is configured to receive an operation command from a user and control the text-appearance formation selector 2 according to the operation command. The operation command from the user can be achieved in various ways. In one embodiment, the operation command may be generated by selecting a menu provided by the mobile terminal according to a physical keyboard or virtual keyboard. In another embodiment, the operation command may be generated by touching at least one selected text in a text view displayed on the mobile terminal with one long touch. In another further embodiment, the operation command may be generated by touching a certain region of the mobile terminal, such as touching a menu or an interface on a touch panel of the mobile terminal. The touching manner may be single-click touching or double-click touching, however, without limitation to the present invention. For the ways of generating the operation command, all modifications and similar arrangements made by one skilled in the art according to the present invention are within the scope of the appended claims. For example, the operation command may be generated by a combination of the above embodiments. FIG. 2A is a schematic view showing that an operation command is generated by touching a selected text in a text view displayed on a mobile terminal with one long touch. As shown in FIG. 2A, a text view 22 is shown on a touch panel of a mobile terminal 21. There is a selected text 23 in the text view 22. An operation command can be generated by touching the selected text 23 with one long touch, such as a first operation command. More details of the text view 22 and the selected text 23 are shown in FIG. 2B, which is a schematic view showing a text view and a selected text. The text view may be a text view shown on any application service, any operation interface, or any operation menu of a mobile terminal (such as a mobile phone, a tablet computer, or a personal digital assistant (PDA), or a digital camera or a smart television installed with an operating system, wherein each of these mobile terminals is installed with an Android system). The selected text may be text which is located in any position in the text view and has any length. For the text view, the modifications and similar arrangements made by one skilled in the art according to the present invention are within the scope of the appended claims. For example, the text view is a text view provided by a message application service, a multimedia messaging application service, or an address book application service.

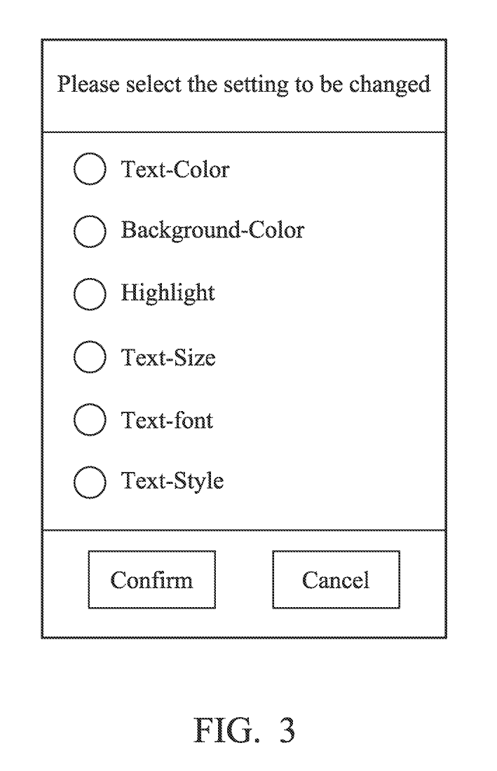

After the command receiver 1 receives the first operation command shown in FIG. 2A, the command receiver 1 transmits the first operation command to the text-appearance formation selector 2. The text-appearance formation selector 2 provides a plurality of setting items of the text-appearance formation according to the first operation command. FIG. 3 is a schematic view showing an exemplary embodiment of setting items of the text-appearance formation. In an embodiment, the setting items of the text-appearance formation can be implemented by the menu shown in FIG. 3. The menu can be displayed on the touch panel of the mobile terminal to provide the various setting items of the text-appearance formation to be selected by the user. The setting items of the text-appearance formation comprise: the text-font setting, the text-size setting, the text-color setting, the background-color setting, the highlight setting, the text-style setting, the indent setting, the width setting of the text view, the alignment setting, the spacing setting, and the color setting of the hyperlinks etc. The text-font setting is provided to set the font of the words in the text. The text-size setting is provided to set the size of the words in the text. The text-color setting is provided to set the color of the words in the text. The background-color setting is provided to set the color of the background of the text view. The highlight setting is provided to set the color of the highlighted words in the text. The text-style setting is provided to set the words of the text to be bold or not. The indent setting is provided to set the distance in which the first row of the text is indented. The width setting of the text view is provided to set the maximum width of the screen showing the text. The alignment setting is provided to set the alignment of the words of the text, such as left-aligned text, right-aligned text, centered text, or justified text. The spacing setting is provided to set the distance between each row of text. The color setting of the hyperlinks is provided to set the color of the letters of the web address on the hyperlinks. There are further various setting items of the text-appearance formation, however, for clarity, all of them are not listed here. The above setting items of the text-appearance formation are given as an example without limitation to the present invention. FIG. 3 lists some setting items of the text-appearance formation.

After the text-appearance formation selector 2 provides the setting items of the text-appearance formation according to the first operation command, an operation command is generated by touching the menu displayed on the touch panel shown in FIG. 3. For example, the selection button on the left side of one setting item of the text-appearance formation is clicked, and “confirm” is then clicked. The clicking operation generates the operation command, such as a second operation command. In the above clicking operation, at least one setting item of the text-appearance formation can be selected. After the command receiver 1 receives the second operation command, the command receiver 1 transmits the second operation command to the text-appearance formation selector 2. The text-appearance formation selector 2 selects at least one setting item of the text-appearance formation according to the second operation command. The generation of the second operation command is not limited to the above embodiment. For the generation of the second operation command, all modifications and similar arrangements made by one skilled in the art according to the present invention are within the scope of the appended claims.

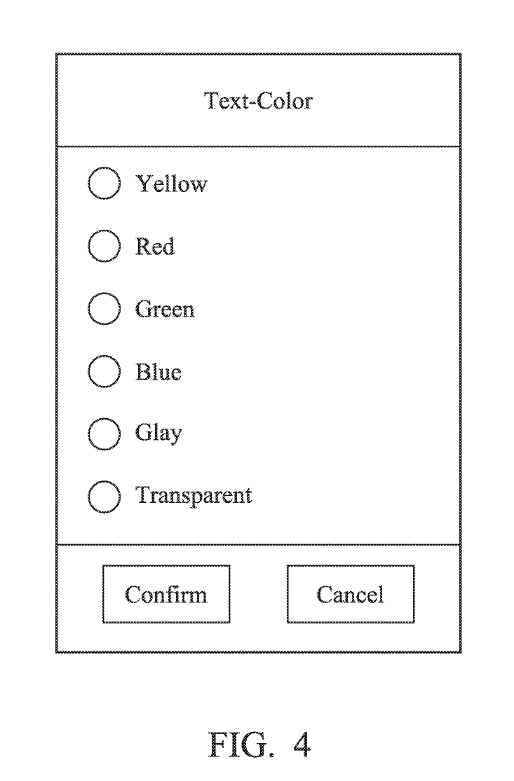

The text-appearance formation transformer 3 is coupled to the text-appearance formation selector 2 and configured to change the text-appearance formation according to the at least one selected setting item(s) of the text-appearance formation. In an embodiment, the user selects the setting item of the text-appearance formation “Text-Color” shown in FIG. 3. In the case where the default text-color of the setting item of the text-appearance formation is specific color, such as red, the text-appearance formation transformer 3 changes the text from the current color (such as black) to red according to the selected setting item of the text-appearance formation, such that the text-appearance formation is changed. In another embodiment, to provide more a brilliant effect to the text-appearance formation, there are a plurality of predetermined setting references in each of the setting items of the text-appearance formation. FIG. 4 is a schematic view showing a plurality of predetermined setting references in a setting item of text-appearance formation. The setting item of text-appearance formation “Text-Color” is given as an example. The predetermined setting references for “Text-Color” comprise Yellow, Red, Green, Blue, Gray, and Transparent etc. An operation command can be generated by touching the menu shown in FIG. 4, such as by clicking the selection button on the left side of “Yellow”, and then “Confirm” is clicked. The clicking operation generates the operation command, such as a third operation command. After the command receiver 1 receives the third operation command, the command receiver 1 transmits the third operation command to the text-appearance formation selector 2. The text-appearance formation selector 2 selects one setting reference, such as “Yellow”, according to the third operation command. The text-appearance formation transformer 3 changes the text from the current color (such as black) to yellow according to the selected setting reference, such that the text-appearance formation is changed.

Note that the device for setting the text-appearance formation according to the above embodiment is used to modify the appearance formation of the local text (such as the text received by or stored in the mobile terminal) but not the text transmitted by the mobile terminal (such as the text transmitted to another mobile terminal). Accordingly, the original operation of the corresponding application of the mobile terminal is not modified, and a corresponding receiving party will not receive any text with the modified appearance which occurred by the modification in the transmitting party. In other words, the text-appearance formation which is modified by the device is the appearance formation of the local text browsed by the user. Thus, using of the device to set the text-appearance formation is simple and flexible, such that the device for setting the text-appearance formation can be applied to mobile terminals of various types.

According to the above embodiment, the device for setting the text-appearance formation provides a manner to individually set the appearance formation of the local text for the user. Accordingly, the user can get a more beautiful, fashionable, and individual text appearance to satisfy personal requirements.

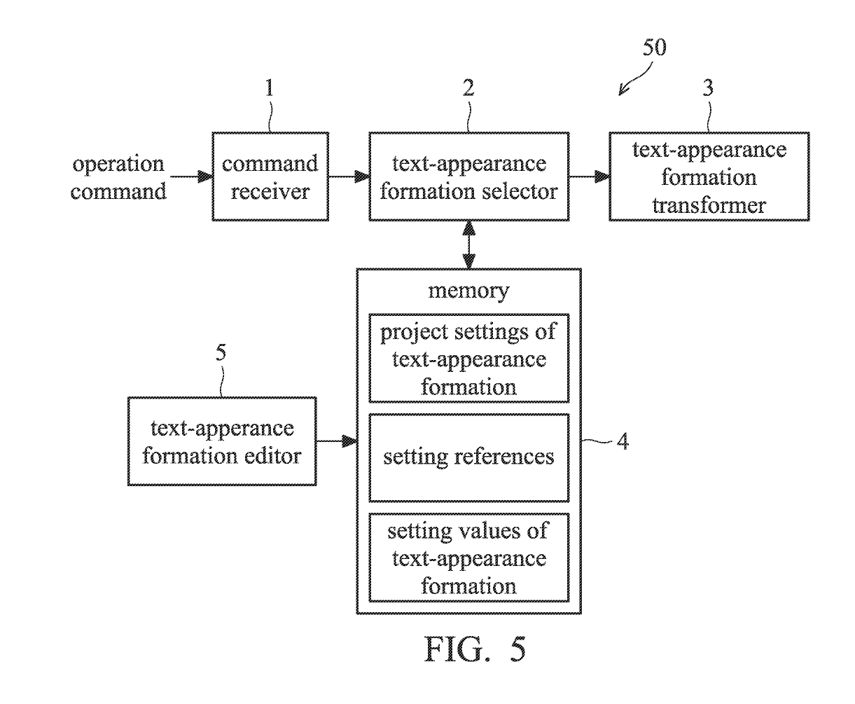

FIG. 5 shows another exemplary embodiment of a device 50 for setting the text-appearance formation of a mobile terminal. As shown in FIG. 5, the device 50 for the setting of text-appearance formation comprises the structure as shown in FIG. 1 and further comprises a memory 4. The memory 4 is coupled to the text-appearance formation selector 2 and configured to store a plurality of setting items for the appearance formation. When the setting items have a plurality of setting references, the memory 4 further stores the setting references. When a user opens a text view and selects at least one section of text in the text view, the text-appearance formation selector 2 retrieves the stored setting items of the text-appearance formation and/or the corresponding setting references from the memory 4 and performs a selection operation according to an operation command of the user. The selected setting items of the text-appearance formation and/or the selected setting references can serve as setting values of the text-appearance formation for the current selected text. The memory 4 further stores the setting values of the text-appearance formation. Thus, when the text view is opened again later, the text is shown in the text view by the effect of the text-appearance formation which has been set previously. In order to provide more individual effects of the text-appearance formation, the device 50 for setting text-appearance formation further comprises a text-appearance formation editor 5. The text-appearance formation editor 5 is coupled to the memory 4 and configured to edit the setting items of the text-appearance formation and the corresponding setting references and store the edited setting items of the text-appearance formation and the edited setting references in the memory 4. For example, in an embodiment, the user can increase the setting items and/or the setting references via the text-appearance formation editor 5. In another embodiment, the user can change the setting items and/or the setting references via the text-appearance formation editor 5 to satisfy the personal requirements of the user.

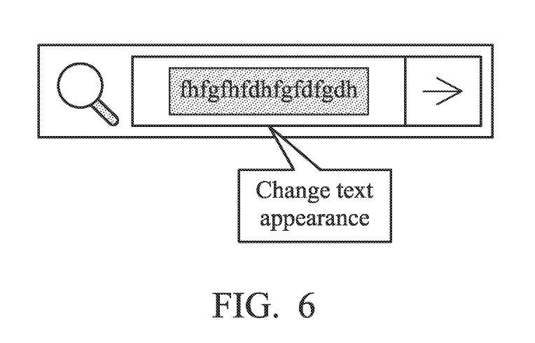

Note that, in order to increase the convenience and provide a simple visual effect for the user, in an embodiment, after the command receiver 1 receives the first operation command and transmits the first operation command to the text-appearance formation selector 2, the text-appearance formation selector 2 provides a pop-up menu. The pop-up menu shows a short message to indicate that the user can modify the text-appearance formation now, such as “change the text appearance”. FIG. 6 is a schematic view showing a pop-up menu. As shown in FIG. 6, the pop-up menu is disposed under the selected text in the text view, however, without limitations to the present invention. The pop-up menu can be disposed in any location around the selected text in the text view for showing the prompted text with any contents and the effect. For the disposition of the pop-up menu, the modifications and similar arrangements made by one skilled in the art according to the present invention are within the scope of the appended claims. When the user clicks the pop-up menu, the text-appearance formation selector 2 then provides the setting items of the text-appearance formation as shown in FIG. 3.

The present invention further provides a mobile terminal which comprises the device for setting the text-appearance formation in any one of the above embodiments. Through the device for setting the text-appearance formation, the text-appearance formation of the application services of the mobile terminal can be set.

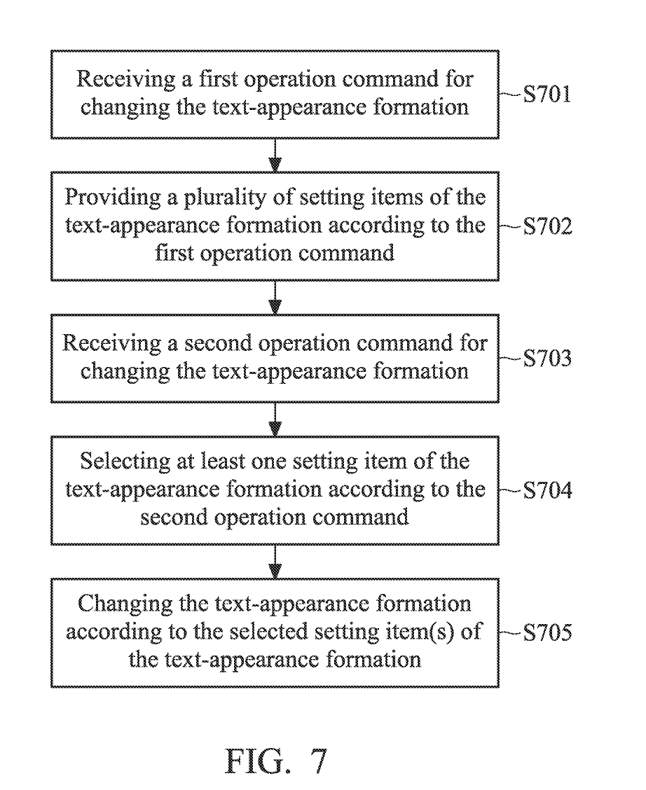

FIG. 7 is a flow chart of an exemplary embodiment of a method for setting text-appearance formation of a mobile terminal. As shown in FIG. 7, the method for setting the text-appearance formation comprises the following steps.

Step S701: receiving a first operation command for changing the text-appearance formation. The first operation command from the user can be achieved by various methods. In one embodiment, the operation command may be generated by selecting a menu provided by the mobile terminal according to a physical keyboard or virtual keyboard. In another embodiment, the operation command may be generated by touching at least one selected text in a text view displayed on the mobile terminal with one long touch. In another further embodiment, the operation command may be generated by touching a certain region of the mobile terminal, such as touching a menu or an interface on a touch panel of the mobile terminal. For the methods of generating the operation command, all modifications and similar arrangements made by one skilled in the art according to the present invention are within the scope of the appended claims. For example, the operation command may be generated by a combination of the above embodiments. As shown in FIG. 2A, in an embodiment, the first operation command is generated by touching the selected text in the text view with one long touch.

Step S702: providing a plurality of setting items of the text-appearance formation according to the first operation command. In an embodiment, the setting items of the text-appearance formation can be implemented by the menu shown in FIG. 3. The menu can be displayed on the touch panel of the mobile terminal to provide the various setting items of the text-appearance formation to be selected by the user. The setting times of the text-appearance formation comprise: the text-font setting, the text-size setting, the text-color setting, the background-color setting, the highlight setting, the text-style setting, the indent setting, the width setting of the text view, the alignment setting, the spacing setting, and the color setting of the hyperlinks etc. The text-font setting is provided to set the font of the words of the text. The text-size setting is provided to set the size of the words of the text. The text-color setting is provided to set the color of the words of the text. The background-color setting is provided to set the color of the background of the text view. The highlight setting is provided to set the color of the highlighted words in the text. The text-style setting is provided to set the words of the text to be bold or not. The indent setting is provided to set the distance in which the first row of the text is indented. The width setting of the text view is provided to set the maximum width of the screen showing the text. The alignment setting is provided to set the alignment of the words of the text, such as left-aligned text, right-aligned text, centered text, or justified text. The spacing setting is provided to set the distance between each row of text. The color setting of the hyperlinks is provided to set the color of the letters of the web address on the hyperlinks. There are further various setting items of the text-appearance formation, however, for clarity, all of them are not listed here. The above setting items of the text-appearance formation are given as an example without limitation to the present invention.

Step S703: receiving a second operation command for changing the text-appearance formation. After the setting items of the text-appearance formation are provided according to the first operation command, an operation command is generated by touching the menu displayed on the touch panel shown in FIG. 3. For example, the selection button on the left side of the setting item of the text-appearance formation is clicked, and “confirm” is then clicked. The clicking operation generates the operation command, such as a second operation command. Then, the second operation command is received.

Step S704: selecting at least one setting item of the text-appearance formation according to the second operation command.

Step S705: changing the text-appearance formation according to the selected setting item(s) of the text-appearance formation. In an embodiment, the user selects the setting item of the text-appearance formation “Text-Color” shown in FIG. 3. When the default text-color of the setting item of the text-appearance formation is a specific color, such as red, the text is changed from the current color (such as black) to red according to the selected setting item of the text-appearance formation, such that the text-appearance formation is changed.

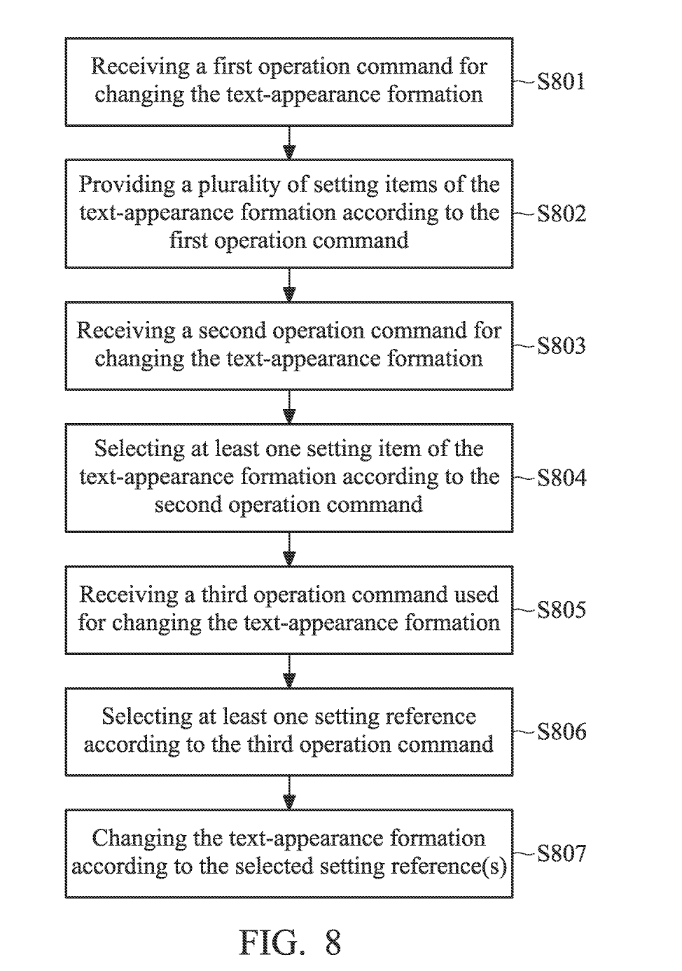

In order to provide a more brilliant effect of the text-appearance formation, there is a plurality of predetermined setting references in each of the setting items of the text-appearance formation. FIG. 8 is a flow chart of another exemplary embodiment of a method for setting text appearance formation of a mobile terminal. As shown in FIG. 8, the method for setting the text appearance formation further comprises the following steps.

Step S805: receiving a third operation command used for changing the text-appearance formation. The setting item of the text-appearance formation “Text-Color” is given as an example. The setting references of “Text-Color” comprise Yellow, Red, Green, Blue, Gray, and Transparent etc. An operation command can be generated by touching the menu on the touch panel of the mobile terminal shown in FIG. 4, such as by clicking the selection button on the left side of “Yellow”, and then “Confirm” is clicked. The clicking operation generates the operation command, such as the third operation command. Then, the third operation command is received.

Step S806: selecting at least one setting reference according to the third operation command, such as selecting at least one setting reference “Yellow” according to the third operation command.

Step S807: changing the text-appearance formation according to the selected setting reference(s), such changing the text in the text view from the current color (such as black) to yellow, such that the text-appearance formation is changed.

Note that Step S801-Step S804 are the same as Step S701-Step S704. For brevity, the related description is omitted here.

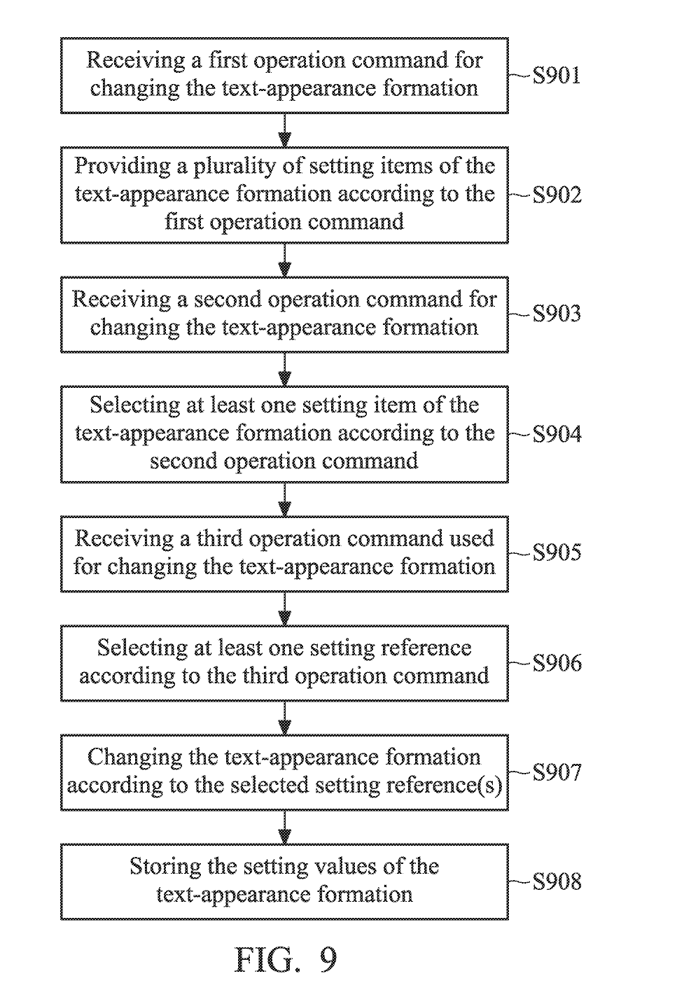

FIG. 9 is a flow chart of another further exemplary embodiment of a method for setting the text-appearance formation of a mobile terminal. As shown in FIG. 9, the method for setting the text-appearance formation comprises the following steps.

Step S908: storing the setting values of the text-appearance formation. After the text-appearance formation is changed in Step S907, the selected setting item(s) of the text-appearance formation and the selected setting values may serve as the setting values of the text-appearance formation of the current selected text, and the setting values of the text-appearance formation is stored. Accordingly, when the text view is opened again later, the text is shown in the text view by the effect of the text-appearance formation which has been set previously. Note that Step S908 for storing the setting values of the text-appearance formation may be performed before Step S907 or after Step S904, however, without limiting the present invention. For the order of the steps in the method, the modifications and similar arrangements made by one skilled in the art according to the present invention are within the scope of the appended claims.

Note that Step S901-Step S907 are the same as Step S801-Step S807. For brevity, the related description is omitted here.

According to the above embodiments, the method for setting the text-appearance formation provides a manner to individually set the appearance formation of the local text for the user. Accordingly, the user can get a more beautiful, fashionable, and individual text appearance to satisfy personal requirements.

One skilled in the art should understand that the embodiments of the present invention can be provided as methods, systems, or computer products. Accordingly, the present invention can be accomplished by embodiments fully having hardware, embodiments fully having software, or embodiments having a combination of hardware and software. Moreover, the present invention can take the form which can be performed in one or more computer programs having a computer-usable storage medium (including disc memory, CD-ROM, and optical memory, however, without limitation) storing computer-usable program codes. For example, the command receiver, the text-appearance formation selector, the text-appearance formation transformer, and the text-appearance formation editor can be implemented by general-purpose computers, special-purpose computers, embedded computers, or other processors which can program data-processing apparatuses.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for setting text-appearance formation of a mobile terminal, comprising:
a command receiver for receiving a first operation command and a second operation command used for changing the text-appearance formation;
a text-appearance formation selector for providing a plurality of setting items of the text-appearance formation according to the first operation command and selecting at least one setting item of the text-appearance formation according to the second operation command; and
a text-appearance formation transformer, coupled to the text-appearance formation selector, for changing the text-appearance formation according to the at least one selected setting item of the text-appearance formation.

2. The device as claimed in claim 1, wherein each of the plurality of setting items of the text-appearance formation comprises a plurality of setting references, the text-appearance formation selector selects at least one setting reference according to a third operation command used for changing the text-appearance formation, the text-appearance formation transformer changes the text-appearance formation according to the at least one selected setting reference, and the third operation command is received by the command receiver.

3. The device as claimed in claim 1, wherein the first operation command is generated by touching at least one selected text in a text view with one long touch.

4. The device as claimed in claim 1, wherein the plurality of setting items of the text-appearance formation comprise text-font setting, text-size setting, text-color setting, background-color setting, highlight setting, text-style setting, indent setting, width setting, alignment setting, spacing setting, and color setting of auto links.

5. The device as claimed in claim 1 further comprising:
a memory for storing the plurality of setting items of text-appearance formation for the text-appearance formation selector and storing at least one setting value of the text-appearance formation.

6. The device as claimed in claim 5 further comprising:
a text-appearance formation editor, coupled to the memory, for editing the plurality of setting items of the text-appearance formation and storing the plurality of edited setting items of the text-appearance formation in the memory.

7. A method for setting text-appearance formation of a mobile terminal comprising
receiving a first operation command used for changing the text-appearance formation;
providing a plurality of setting items of the text-appearance formation according to the first operation command;
receiving a second operation command used for changing the text-appearance formation;
selecting at least one setting item of the text-appearance formation according to the second operation command; and
changing the text-appearance formation according to the at least one selected setting item of the text-appearance formation.

8. The method as claimed in claim 7,
wherein each of the plurality of setting items of the text-appearance formation comprises a plurality of setting references;
wherein the method further comprises:
receiving a third operation command used for changing the text-appearance formation;
selecting at least one setting reference according to the third operation command; and
changing the text-appearance formation according to the at least one selected setting reference.

9. The method as claimed in claim 7, wherein the first operation command is generated by touching at least one selected text in a text view with one long touch.

10. The method as claimed in claim 7, wherein the plurality of setting items of the text-appearance formation comprise text-font setting, text-size setting, text-color setting, background-color setting, highlight setting, text-style setting, indent setting, width setting, alignment setting, spacing setting, and color setting of auto links.

11. The method as claimed in claim 7 further comprising:
storing the plurality of setting items of text-appearance formation; and
storing at least one setting value of the text-appearance formation.

12. The method as claimed in claim 11 further comprising:
editing the plurality of setting items of the text-appearance formation; and
storing the plurality of edited setting items of the text-appearance formation.

13. A mobile terminal, comprising:
a device for setting text-appearance formation of a mobile terminal, wherein the device comprising:
a command receiver for receiving a first operation command and a second operation command used for changing the text-appearance formation;
a text-appearance formation selector for providing a plurality of setting items of the text-appearance formation according to the first operation command and selecting at least one setting item of the text-appearance formation according to the second operation command; and
a text-appearance formation transformer, coupled to the text-appearance formation selector, for changing the text-appearance formation according to the at least one selected setting item of the text-appearance formation.

14. The mobile terminal as claimed in claim 13, wherein each of the plurality of setting items of the text-appearance formation comprises a plurality of setting references, the text-appearance formation selector selects at least one setting reference according to a third operation command used for changing the text-appearance formation, the text-appearance formation transformer changes the text-appearance formation according to the at least one selected setting reference, and the third operation command is received by the command receiver.

15. The mobile terminal as claimed in claim 13, wherein the first operation command is generated by touching at least one selected text in a text view with one long touch.

16. The mobile terminal as claimed in claim 13, wherein the plurality of setting items of the text-appearance formation comprise text-font setting, text-size setting, text-color setting, background-color setting, highlight setting, text-style setting, indent setting, width setting, alignment setting, spacing setting, and color setting of auto links.

17. The mobile terminal as claimed in claim 13, wherein the device further comprising:
a memory for storing the plurality of setting items of text-appearance formation for the text-appearance formation selector and storing at least one setting value of the text-appearance formation.

18. The mobile terminal as claimed in claim 17, wherein the device further comprising:
a text-appearance formation editor, coupled to the memory, for editing the plurality of setting items of the text-appearance formation and storing the plurality of edited setting items of the text-appearance formation in the memory.
